(19) United States
(12) Patent Application Publication
(10) Pub. No.: US 2016/0217689 A1
(43) Pub. Date: Jul. 28, 2016

(54) SUPPLEMENTAL AUTOMOTIVE SAFETY METHOD AND SYSTEM

(71) Applicant: Autoliv ASP, Inc., Ogden, UT (US)

(72) Inventor: James M. Young, Brighton, MI (US)

(73) Assignee: Autoliv ASP, Inc.

(21) Appl. No.: 14/604,879

(22) Filed: Jan. 26, 2015

(51) Int. Cl. G08G 1/0965; B60W 10/30; B60W 10/18; B60W 40/04; B60W 10/20

(52) U.S. Cl. CPC G08G 1/0965; B60W 40/04; B60W 10/20; B60W 10/18; B60W 10/30; B60W 2420/54; B60W 2550/10

(57) ABSTRACT

A method and system for mitigating an imminent collision of a vehicle performs the steps of detecting a sound near an outer periphery of the vehicle in at least one location; processing the sound by analyzing sound characteristics including at least one of a frequency of the sound or a volume of the sound; estimating a threat; and initiating a safety response of the vehicle.

### TECHNICAL FIELD

The present invention pertains to a method and a system for improving automotive safety. In particular, the invention pertains to a method and a system improving a vehicle's response to situations, in which the vehicle might collide with other vehicles in flowing traffic.

### BACKGROUND

The development of autonomous driving (AD) vehicles will require the vehicles to determine if adjacent lanes are free from other vehicles prior to changing lanes. A variety of sensors, such as radar, lidar, and cameras, can be used for this purpose. However, if an incorrect determination is made or a change in the lane status changes suddenly the AD vehicle may change lanes into another vehicle causing a collision. A typical driver response to a vehicle encroaching into their lane is to sound the horn.

Also, in vehicles operated by human drivers, the multitude of sensory demands may cause a driver to encroach on the path of another vehicle because the driver may not always be aware of all traffic participants in the vicinity of the vehicle. In particular, vehicles in blind spots of the rear view mirrors may not be noticed.

Additionally, during panic braking situations, there is a significant amount of compliance (brake lines, distance from brake pads to rotors, etc.) that needs to be taken up in a traditional hydraulic braking system before brake torque is actually generated at the wheels. This takes time and can increase the stopping distance.

It is thus an objective of the present invention to provide a supplemental safety system that reduces the risk of collisions, mitigates the risk of damage and injury, but does not further flood a driver with additional sensory inputs.

It is a further objective of the present invention to improve the navigation of autonomous vehicles.

### SUMMARY OF THE INVENTION

These objectives are met by a method of mitigating an imminent collision of a vehicle that involves the steps of using a microphone for detecting a sound near an outer periphery of the vehicle in at least one location; processing the sound by analyzing sound characteristics including at least one of the frequency, pattern or volume of the sound; estimating a threat; and initiating a safety response of the vehicle. The term “sound” in this context means primarily sound waves in the audible range of human hearing, which is between about 20 and 20,000 Hz.

The sound may be detected in a plurality of locations so that a direction of the sound may be determined by evaluating simultaneous detections of the sound.

The safety response may include, but is not limited to, an activation of a vehicle horn, reducing a gap between a brake pad and a rotating brake surface, for example by pre-filling calipers of hydraulic brakes, activating vehicle brakes to slow down the vehicle, or a change of a steering angle, or activating driver alert signals which may be audible, visual, or haptic.

The step of processing the sound may include comparing the sound characteristics to known sound characteristics stored in a library of sound profiles and identifying a sound source. The safety response may thus be selected from a plurality of safety responses based on the identified sound source.

The safety response may further be selected based on at least a direction or a distance of the sound source, depending on a severity of a threat level.

Further details and advantages will become apparent from the following description of the accompanying drawings that illustrate a method and a system according to the invention. The drawings are provided for purely illustrative purposes and are not intended to limit the scope of the present invention.

### BRIEF DESCRIPTION OF THE DRAWINGS

In the drawings,

FIG. 1 shows a first traffic situation, in which a first vehicle equipped with a system performing a method according to the present invention encroaches on the path of a second vehicle;

FIG. 2 shows a second traffic situation, in which the second vehicle encroaches on the path of the first vehicle; and

FIG. 3 illustrates a system performing a method according to the present invention.

### DETAILED DESCRIPTION OF THE DRAWINGS

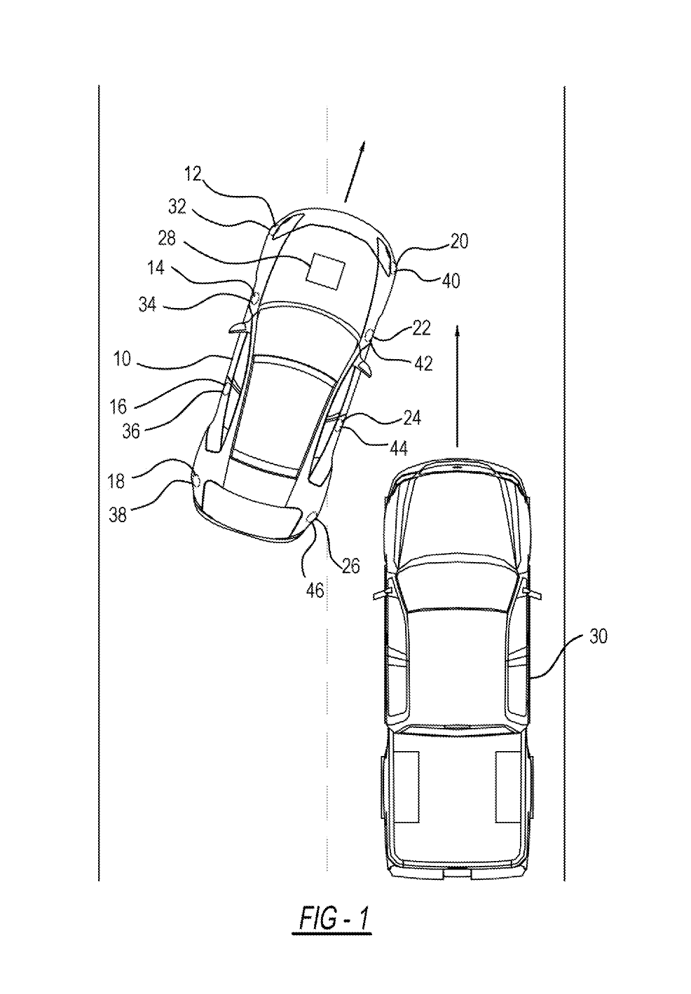

FIG. 1 shows a first traffic situation involving a first vehicle 10 equipped to perform a method according to one aspect of the present invention.

The first vehicle 10 includes a plurality of auditory sensors near the periphery of the first vehicle 10, for example microphones. The auditory sensors are positioned to detect sounds on the outside of the first vehicle 10. In the shown example, the first vehicle 10 is equipped with eight microphones 12, 14, 16, 18, 20, 22, 24, and 26. Four of the microphones 12-18 are arranged near the outer perimeter of the first vehicle 10 on the left side relative to the forward direction of the first vehicle 10, and the other four microphones 20-26 are arranged on the right side of the vehicle. On each of the left and right sides, the microphones are distributed over the length of the first vehicle 10. For example, a front pair of microphones 12 and 20 is located near the front corners of the first vehicle 10, for example in portions of a front bumper structure. A front-center pair of microphones 14 and 22 is located near the so-called A pillar of the first vehicle 10 or near the front of the vehicle driver door and the vehicle front passenger door. A rear-center pair of microphones 16 and 24 is arranged near the so-called B pillar or just behind the vehicle driver door and the vehicle front passenger door. And a rear pair of microphones 18 and 26 is located near the rear corners of the first vehicle 10, for example in portions of a rear bumper structure.

The arrangement and the number of the microphones may be varied. For example, on each side, the microphone 16 or 24, respectively, in the rear-center position may be combined with the microphone 18 or 26, respectively, in the front-center position into one center microphone on each side for a total of six microphones. In yet another embodiment, the front microphones 12 and 20 may be omitted, especially in non-autonomous vehicles, because the front of the vehicle is within the driver's view and thus has a lesser need for an additional sound evaluation. It may be sufficient to provide only four microphones 12, 20, 18, and 26 at the corners of the vehicle. If highly sensitive microphones are chosen, three microphones arranged in a horizontal triangle may be sufficient to determine the direction and location of a sound as will be described in more detail below.

In FIG. 1, the first vehicle 10 travels on a two-lane roadway in the left lane. A second vehicle 30 travels in the right lane slightly offset rearward from the first vehicle 10, but in a position overlapping with the length of the first vehicle 10. In the situation shown in FIG. 1, the first vehicle 10 attempts to merge into the right lane and thus moves into the path of the second vehicle 30.

As the rear portion first vehicle 10 approaches the front portion of the second vehicle 30, the microphones 12-26 detect the sound of the engine of the second vehicle 30. In the shown situation, for example, the right center-rear microphone 24 and the right rear microphone 26 detect a higher amplitude of the engine noise than the other microphones. the absolute amplitude detected by each microphone depends not only on the direction, from which the sound is received, but also on the absolute distance of the sound source from the first vehicle 10.

Furthermore, the driver of the second vehicle 30 may fear an impending collision and thus activate the second vehicle's horn to warn the driver of the first vehicle 10. Again, the right center-rear microphone 24 and the right rear microphone 26 will detect a higher amplitude of the horn than the other microphones. Other sounds that may be detected are tire screeching and metal-on-metal contact sounds indicating a crash or collision, where the absolute amplitude and the direction of the sound can be considered for selecting an appropriate automated response.

If a different arrangement of microphones is chosen, the sound amplitude varies accordingly in analogy to the description above, depending on the locations of the microphones.

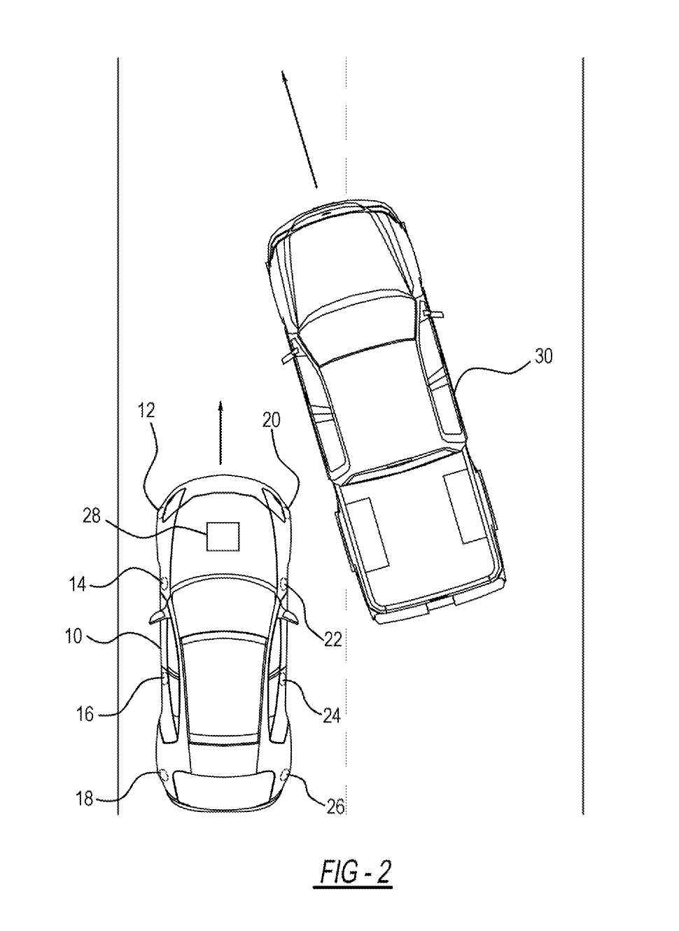

FIG. 2 shows a second traffic situation involving the first vehicle 10 equipped to perform the method according to another aspect of the present invention. The first vehicle 10 travels on a two-lane roadway in the left lane. The second vehicle 30 travels in the right lane slightly offset forward from the first vehicle 10, but in a position overlapping with the length of the first vehicle 10. In the situation shown in FIG. 2, the second vehicle 30 attempts to merge into the left lane, thus moving into the path of the first vehicle 10. The driver of the second vehicle 30 may not be aware of the first vehicle 10 because the first vehicle 10 may be positioned to be in a blind spot of the second vehicle's rear view mirrors.

As the front portion first vehicle 10 approaches the second vehicle 30, the microphones 12-26 detect the sound of the engine of the second vehicle 30. In the shown situation, for example, the right front microphone 20 will detect a higher amplitude of the engine noise than the other microphones. Not only the engine noise of the second vehicle 30 is detected, but also the engine noise of the first vehicle 10 as it is reflected by the side of the second vehicle 30. The reflected engine noise may, for example be considered during a calculation of the distance and location of the second vehicle 30. Again, further sounds may include vehicle horns, tire screeching, or crashes. These sounds can be an indication that the first vehicle may need to perform an immediate hard braking operation or evasive maneuver.

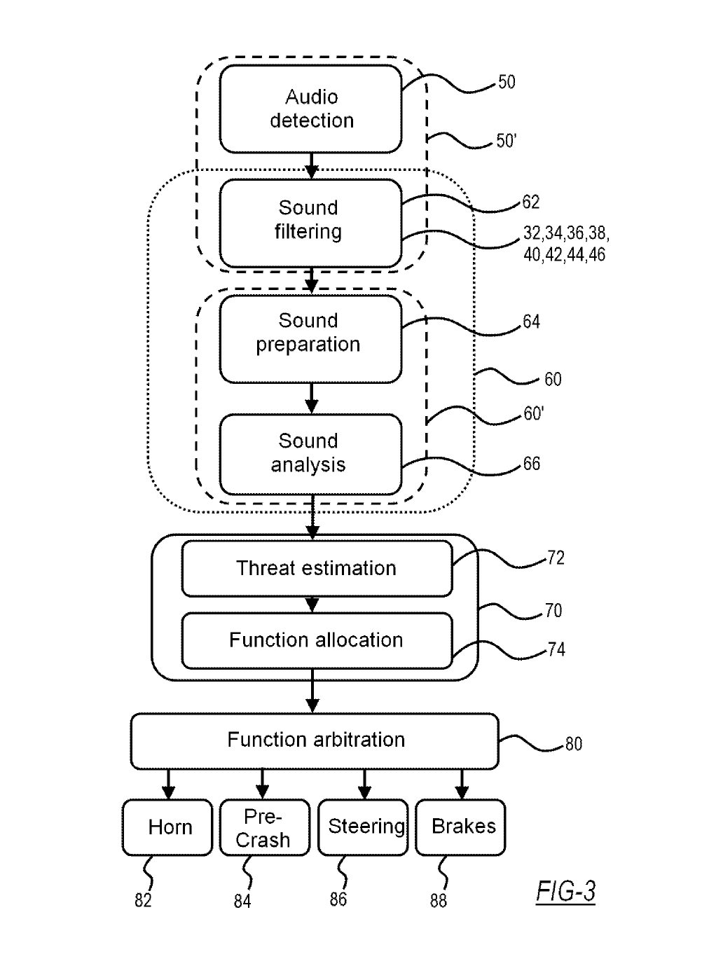

Now referring to FIG. 3, the environmental sounds are detected in an audio detection module 50 comprising a plurality of microphones, such as microphones 12-26. The detected sounds are processed in a sound processing module 60 for identifying a source and are transferred to a situational assessment module 70 for initiating a safety response.

Prior to any further analysis of the detected sounds, the sounds may be filtered in one or more sound filtering units. For example, individual sound filtering units 32-46 (see FIG. 1) may be integrated with the microphones into the audio detection module 50′, thus filtering the detected sounds prior to any transmission to the CPU 28. The sound filtering units 32-46 may each be formed by an individual microprocessor that filters out noise and frequencies that are irrelevant for a safety evaluation, for example the engine noise of the first vehicle 10. Such local sound filtering reduces the amount of data that needs to be transferred to the CPU 28. In FIG. 3, boxes drawn in dashed lines indicate the grouping of the sound filtering units with the individual microphones 12-26, where the further sound processing is performed in a central sound processing module 60′, to which the filtered sound information is forwarded from the sound filtering units 32-46 of the audio detection module 50′.

Accordingly, the limited data can be forwarded faster than in systems that transmit all unfiltered data to a sound processing module 60, where a greater data amount needs to be received before the sounds can be processed and evaluated.

Alternatively, for example for cost-saving reasons, the unfiltered detected sound information may be transmitted to the central sound processing module, where the sound filtering may be performed in a central sound filtering unit 62 after the transmission. This sound processing module 60 including the central sound filtering unit 62 is shown as a box drawn in a dotted line.

The CPU 28 includes a sound processing module that performs several functions. For example, the sound processing module includes a sound preparation unit 64 configured to prepare the received sound information for identification. The sound preparation maps out sound characteristics that may later be compared with known sound profiles. The sound characteristics may include, but are not limited to, frequencies, amplitude variations over time, or spatial amplitude distributions indicating more than one location of sound sources.

The sound processing module further includes a sound analysis unit 66 that determines the location of the source of the sound, for example the location of the engine of the second vehicle 30 or of the horn in the example of FIG. 1, from the spatial distribution of the detected sound amplitudes. If more than one sound source is present in the vicinity of the first vehicle 10, these sounds may, for example, be distinguished by their sound characteristics mapped out in the sound preparation unit 64. Thus, simultaneous sounds with common characteristics from various microphones may be evaluated together, and simultaneous sounds with different characteristics may be evaluated separately.

In addition to determining the location of a sound source, the sound analysis unit 66 further includes a library of stored sound profiles indicative of an identifiable source. Each sound profile thus includes properties of a sound or noise that are distinguishable from sounds from a different source. For example, an engine sound provides or a periodical amplitude variation caused by the cylinders of an engine. On the other hand, a horn sound includes one or more specific sound frequencies at a generally constant amplitude over time. These and other sound profiles may be represented by multi-dimensional mapping, where dimensions may be formed by time, frequency, and amplitude. The mapped amplitude values may be relative, for instance expressed as a percentage of a maximum amplitude or of an average amplitude of a mapped sound, so that the sound mapping is applicable to various absolute amplitude levels due to different distances of the sound source from the microphones.

After determining the location and nature of a detected sound, a situational assessment module 70 of the CPU 28 performs a threat estimation in threat estimation unit 72. Several factors may be considered, such as the nature of the sound, the distance of the sound source from the first vehicle 10, the relative movement between the sound source and the first vehicle 10, etc. Depending on the threat calculated in the threat estimation unit 72, the situational assessment module 70 further includes a function allocation unit 74 that determines whether an appropriate action is available to mitigate the estimated threat. Available functions for countering the estimated threat may include, without limitation, an activation of the horn 82 of the first vehicle 10, a pre-crash preparation 84 of available safety systems, such as pretensioning a seatbelt or a caliper pre-fill (CPF) of the vehicle brakes to place the respective safety system in a state of readiness, an adjustment of the first vehicle's steering system 86, or an actuation of the brakes 88 to slow the first vehicle 10 down. A further available function may be a vehicle acceleration (not shown) to escape an impending collision.

For example, the situation of FIG. 1 may trigger a steering correction to maneuver the first vehicle 10 back into the left lane, or an acceleration of the first vehicle 10, or both. A warning may be issued to the driver in the form of a visual, audible, or haptic signal. The situation shown in FIG. 2 may effect an activation of the horn 82 of the first vehicle 10 and a CPF function of the vehicle's hydraulic brakes via the pre-crash preparation 84 that builds up a small brake fluid pressure to reduce a gap between the brake pads and rotating brake surface, which may be a brake disc or brake drum, respectively. This principle applies in analogy to the type of brake-by-wire systems that actuate the vehicle brakes via electric motors. The electric motor may be briefly activated to move the brake pads closer to the rotating brake surface by a predetermined distance. Also, a warning may be issued to the driver in the form of a visual, audible, or haptic signal.

If the threat level is elevated and an active influence on the vehicle behavior is advisable, the vehicle brakes 88 may be actuated to slow the first vehicle 10 down. Additionally, seatbelt pretensioners (preferably reversible types also known as pre-pretensioners) may be triggered via the pre-crash preparation 84 if a collision appears to be imminent.

The available appropriate actions or functions differ between vehicles with a human driver and autonomously driven vehicles. For example, a correction of a steering angle to move the first vehicle 10 away from the second vehicle 30 back into the left lane is an appropriate action for an autonomous vehicle in the situation shown in FIG. 1. For a vehicle with a human driver, such an interference with the driver's control of the vehicle may scare or irritate the driver and should thus be rare and limited. Similar considerations apply to an acceleration of the vehicle. An activation of the vehicle brakes independent of an input from the driver, however, is generally considered safe. If a collision seems unavoidable, the pre-crash preparation of the available safety systems may be activated.

The described sound-based safety system typically needs to operate along with other vehicle safety systems. Active safety systems are generally such systems that operate toward the prevention of an accident, while passive safety systems mitigate the damage resulting from an accident. Active safety systems include, for example, electronic stability control systems, and passive safety systems include airbags and seatbelt systems. Different active and passive safety systems monitor different conditions and may thus come to conflicting conclusions regarding appropriate functions to activate in order to mitigate dangerous situations. For example, current brake systems may be designed with a CPF function that receives inputs from a driver brake pedal apply rate, radar, and airbag controllers. In view of the different, potentially conflicting, commands from different safety systems, it is preferred that a function arbitration is performed in a function arbitration module 80 that considers inputs from the various safety systems and provides mutually consistent commands to the devices performing the allocated functions.

While in FIGS. 1 and 2 situations are shown that involve a lane-changing maneuver by one of the two depicted vehicles 10 and 30, the sound-based safety system is not limited to the situations shown. For example, the sound-based safety system may facilitate various other maneuvers, such as a turn at an intersection or into a driveway, or a straight path through an intersection that is being crossed by another vehicle.

While the above description constitutes the preferred embodiment of the present invention, it will be appreciated that the invention is susceptible to modification, variation, and change without departing from the proper scope and fair meaning of the accompanying claims. In particular, the allocation of functional units to combined modules may vary depending on the type of vehicle equipped with the disclosed sound-based safety system.

1. A method of mitigating an imminent collision of a vehicle, the method comprising the steps of
detecting a sound near an outer periphery of the vehicle in at least one location;
processing the sound by analyzing sound characteristics including at least one of a frequency of the sound or a volume of the sound;
estimating a threat; and
initiating a safety response of the vehicle, wherein the safety response includes at least one of an activation of a vehicle horn or a seatbelt pretensioner.

2. The method according to claim 1, wherein the sound is detected in a plurality of locations, further including the step of determining a direction of the sound by evaluating simultaneous detections of the sound.

3. The method according to claim 1, wherein the safety response includes the activation of the vehicle horn.

4. A method of mitigating an imminent collision of a vehicle, the method comprising the steps of
detecting a sound near an outer periphery of the vehicle in at least one location;
processing the sound by analyzing sound characteristics including at least one of a frequency of the sound or a volume of the sound;
estimating a threat; and
initiating a safety response of the vehicle;
wherein the safety response includes reducing a gap between a brake pad and a rotating brake surface.

5. The method according to claim 1, wherein the safety response includes activating vehicle brakes.

6. The method according to claim 1, wherein the safety response includes a change of a steering angle.

7. The method according to claim 1, wherein the step of processing the sound includes the step of comparing the sound characteristics to known sound characteristics stored in a library of sound profiles and identifying a sound source.

8. The method according to claim 7, further comprising the step of selecting the safety response from a plurality of safety responses based on the identified sound source.

9. The method according to claim 8, wherein the safety response is further selected based on at least a direction or a distance of the sound source.

10. The method according to claim 1, wherein the step of processing the sound includes the step of analyzing a time dependency of the volume of the sound.

11. The method according to claim 1, wherein the step of processing the sound includes the step of analyzing a time dependency of a plurality of frequencies of the sound.

12. A system for mitigating an imminent collision of a vehicle, the system comprising
an auditory detection unit for detecting a sound near an outer periphery of the vehicle in at least one location;
a sound processing module for processing the sound by analyzing sound characteristics including at least one of a frequency of the sound or a volume of the sound; and
situational assessment module for estimating a threat and for initiating a safety response of the vehicle by generating a command for at least a horn or a seatbelt pretensioner.

13. The system according to claim 12, wherein the auditory detection unit comprises a plurality of microphones detecting sounds in a plurality of locations.

14. The system of claim 13, wherein the auditory detection unit is configured to filter detected sounds for reducing irrelevant noise.

15. The system according to claim 13, wherein the sound processing module is configured to determine a direction of a sound by evaluating simultaneous detections of the sound.

16. The system according to claim 12, wherein the sound processing module includes a library of sound profiles for identifying sound sources.

17. The system according to claim 12, wherein the situational assessment module is configured to assess a threat and to select and initiate one of a variety of safety functions.

18. The system according to claim 12, further comprising an arbitration module configured to receive commands from the situational assessment module and from other safety modules of the vehicle, the arbitration module configured to evaluate the commands and to issue an overriding command upon receiving conflicting commands.

19. The system according to claim 12, wherein the situational assessment module is configured to initiate the safety response by further generating a command for a wheel brake pre-fill.
